(19) United States
(12) Patent Application Publication
(10) Pub. No.: US 2026/0208515 A1
(43) Pub. Date: Jul. 23, 2026

(54) PRINTING DEVICE

(71) Applicant: SEIKO EPSON CORPORATION, Tokyo (JP)

(72) Inventors: Yoichi KOBAYASHI, MATSUMOTO-SHI (JP); Akimasa NOZAWA, TATSUNO-MACHI (JP)

(21) Appl. No.: 19/448,202

(22) Filed: Jan. 14, 2026

(30) Foreign Application Priority Data
Jan. 17, 2025 (JP) 2025-006980

(51) Int. Cl. B41J 19/00; B41J 29/02

(52) U.S. Cl. CPC B41J 19/005; B41J 29/02

(57) ABSTRACT

A printing device includes a carriage on which an inkjet head is mounted, a control unit that controls the inkjet head, a first flexible flat cable that electrically couples the carriage and the control unit and in which electric wires are disposed in parallel along a width direction, a second flexible flat cable that electrically couples the carriage and the control unit and in which electric wires are disposed in parallel along the width direction, and a clamp that holds the first flexible flat cable and the second flexible flat cable, in which the clamp includes a support surface which supports each of the first flexible flat cable and the second flexible flat cable from one end in the width direction in a posture in which the other end in the width direction is higher than one end in the width direction in terms of a vertical direction.

The present application is based on, and claims priority from JP Application Serial Number 2025-006980, filed Jan. 17, 2025, the disclosure of which is hereby incorporated by reference herein in its entirety.

### BACKGROUND

### 1. Technical Field

The present disclosure relates to a printing device.

### 2. Related Art

JP-A-2020-019175 discloses an inkjet printer in which a noise caused by a collision between a clamp coupled to a coupling member and a support member is reduced. The inkjet printer of JP-A-2020-019175 includes: a carriage that has an inkjet head and can scan a recording medium; a main body substrate having a control unit that controls the carriage; a coupling member that couples the carriage and the main body substrate and has an elongated shape; a support member that supports the coupling member vertically below; and an ink tube that couples the inkjet head and an ink tank disposed outside the carriage, in which the coupling member includes a first cable coupled to a first substrate provided at the carriage, a second cable coupled to a second substrate provided at the carriage and having a width different from that of the first cable, and a clamp that bundles the first cable and the second cable, and the ink tube is disposed between the coupling member and the support member.

JP-A-2020-019175 is an example of the related art.

In the printing device as disclosed in JP-A-2020-019175, when the carriage moves, the positions of the two cables are shifted, which may cause a noise.

### SUMMARY

According to an aspect of the present disclosure, a printing device includes: a carriage on which an inkjet head is mounted and which can scan a print medium; a control unit which controls the inkjet head; a first flexible flat cable which electrically couples the carriage and the control unit and in which a plurality of electric wires are disposed in parallel along a width direction; a second flexible flat cable which electrically couples the carriage and the control unit and in which a plurality of electric wires are disposed in parallel along the width direction; and a clamp which holds the first flexible flat cable and the second flexible flat cable, in which the clamp includes a support surface which supports each of the first flexible flat cable and the second flexible flat cable from one end in the width direction in a posture in which the other end in the width direction is higher than one end in the width direction in terms of a vertical direction.

### BRIEF DESCRIPTION OF THE DRAWINGS

FIG. 1 is a perspective view of a printing device according to a first embodiment of the present disclosure.

FIG. 2 is a plan view showing the internal structure of the printing device.

FIG. 3 is a cross-sectional view taken along a line III-III in FIG. 2.

FIG. 4 is a cross-sectional view taken along the line III-III in FIG. 2.

FIG. 5 is a cross-sectional view of a clamp according to a second modification example.

### DESCRIPTION OF EMBODIMENTS

An embodiment of the present disclosure will now be described with reference to the drawings.

In each drawing, a reference sign FR indicates a forward direction in relation to a printing device 1 in a state of being installed on an installation surface and used normally, a reference sign UP indicates an upward direction in relation to the printing device 1, and a reference sign LH indicates a leftward direction in relation to the printing device. In the description below, each direction is a direction along these directions in relation to the printing device 1. A front-rear direction and a left-right direction of the printing device 1 coincide with the horizontal direction, and an up-down direction coincides with the vertical direction.

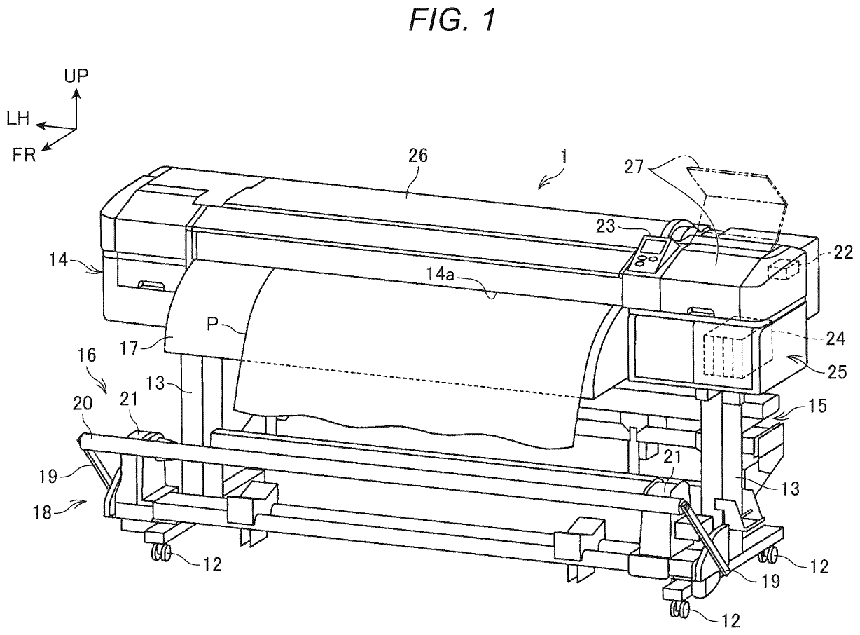

FIG. 1 is a perspective view illustrating the printing device 1 according to an embodiment of the present disclosure.

As illustrated in FIG. 1, the printing device 1 is a large-format printer (LFP) that handles a long paper P, which is an example of a print medium. The printing device 1 includes a pair of leg parts 13 having wheels 12 attached to the lower ends thereof, and a housing 14 assembled to upper parts of the leg parts 13.

A feeding unit 15 that feeds the paper P toward the housing 14 is disposed below the rear side of the housing 14. A take-up unit 16 that winds up the paper P discharged from the housing 14 is disposed below the front side of the housing 14. Between the feeding unit 15 and the take-up unit 16, a guide part 17 is disposed along the conveyance path of the paper P. The guide part 17 has a rear end side accommodated in the housing 14 and a front end side protruding forward from the housing 14. On the front side of the housing 14, a discharge port 14a for discharging the paper P from the housing 14 is formed at a position above the guide part 17.

A tension applying mechanism 18 that applies a tension to the paper P positioned between the guide part 17 and the take-up unit 16 is provided at a position near the take-up unit 16. The tension applying mechanism 18 includes a pair of arm members 19 supported to be rotationally movable at lower parts of the leg parts 13, and a tension roller 20 supported at distal end parts of the pair of arm members 19. Also, the take-up unit 16 includes a pair of holders 21 that hold a core member such as a paper tube for winding up the paper P after printing into a cylindrical shape, from both sides in the axial direction.

The housing 14 includes a control unit 22 that controls the operation of the printing device 1, an operation panel 23 for performing a setting operation and an input operation on the printing device 1, and a cartridge holder 25 on which a plurality of ink cartridges 24 that can contain an ink are detachably mounted. The control unit 22 is provided inside the housing 14 of the printing device 1, and the operation panel 23 is provided at an upper part of the housing 14. The control unit 22 and the operation panel 23 are electrically coupled inside the housing 14. Also, the cartridge holder 25 is provided at a right end part which is outside the conveyance path of the paper P in the scanning direction in a lower part of the housing 14.

The housing 14 includes a case 26 that covers the entire upper part, and an open-close panel 27 formed at the case 26. The open-close panel 27 is provided on a first end side, which is the right side of the upper part of the housing 14, and is provided to be rotatable in relation to the case 26, as indicated by a two-dot chain line in FIG. 1.

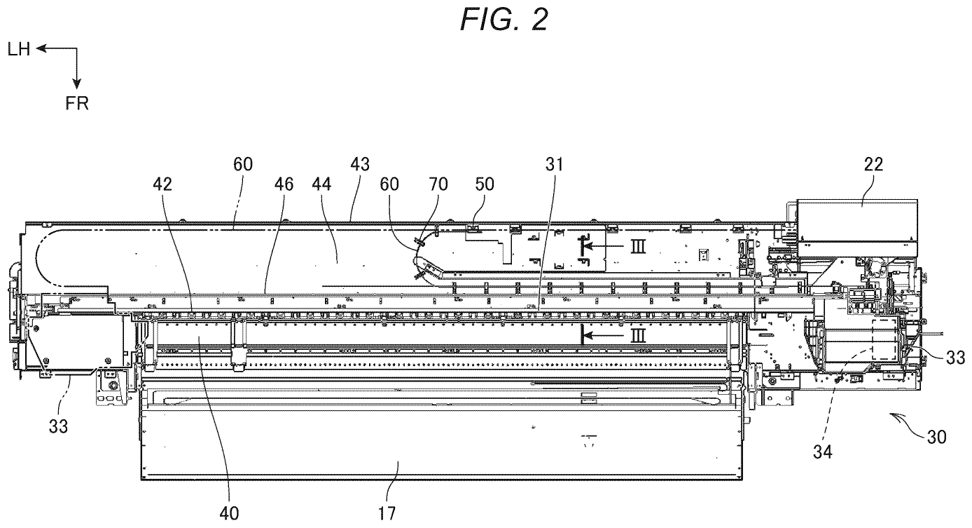

FIG. 2 is a plan view illustrating the internal structure of the printing device 1. In FIG. 2, in the printing device 1, the housing 14 is not illustrated, and each unit accommodated inside the housing 14 is illustrated. FIG. 2 illustrates the state of a carriage 33 and a cable unit 60 when the printing device 1 does not perform printing. In FIG. 2, the carriage 33 located at a right end part of a scanning shaft 31 is indicated by a solid line, and the carriage 33 located at a left end part and the cable unit 60 are indicated by two-dot chain lines.

Next, each part housed inside the housing 14 will be described.

As illustrated in FIG. 2, the printing device 1 includes a printing unit 30 that prints an image of a character, a geometric shape or the like on the paper P inside the housing 14. The printing unit 30 includes the scanning shaft 31. The scanning shaft 31 extends in the left-right direction. As the scanning shaft 31, for example, two shafts may be arranged in parallel along the up-down direction.

The printing unit 30 includes the carriage 33 movably supported by the scanning shaft 31, and an inkjet head 34 supported by the carriage 33 and moving forward and backward along the scanning shaft 31 together with the carriage 33.

The ink cartridge 24 and the inkjet head 34 are coupled together by an ink tube 35. In the present embodiment, four ink tubes 35 couple each of the ink cartridges 24 and the inkjet head 34. The ink tube 35 is a tubular member having flexibility. Thus, the ink stored in each of the ink cartridges 24 is supplied to the inkjet head 34 via the ink tube 35.

The inkjet head 34 moves in the left-right direction, which is the scanning direction, together with the carriage 33. That is, the inkjet head 34 ejects the ink on the paper P while moving forward and backward in the left-right direction in relation to the paper P, and thus prints an image on the paper P.

In the present embodiment, when the printing device 1 does not perform printing, the carriage 33 is disposed at the right end part of the scanning shaft 31.

In the printing unit 30, a support surface part 40 having a flat surface orthogonal to the up-down direction is provided on the front side of the scanning shaft 31. The support surface part 40 is disposed between the scanning shaft 31 and the guide part 17 in the front-rear direction, and is located below the scanning shaft 31 in the up-down direction.

The support surface part 40 supports the paper P from below when the inkjet head 34 ejects the ink onto the paper P to print an image on the paper P.

A conveyance roller 42 is provided below the scanning shaft 31. The conveyance roller 42 functions as a conveyance unit that rotates and thus conveys the paper P from the rear to the front.

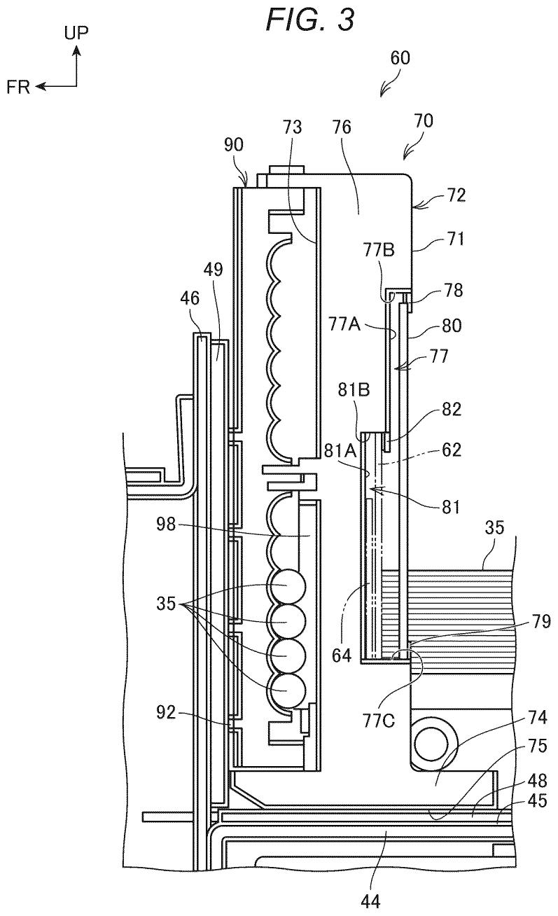

FIG. 3 is a cross-sectional view taken along a line III-III in FIG. 2. FIG. 3 is a cross-sectional view of the moving clamp 70 in a plane orthogonal to the scanning direction of the carriage 33 and intersecting the ink tube 35, a first cable 62, and a second cable 64.

As illustrated in FIGS. 2 and 3, in the printing unit 30, a plate-shaped placement frame 44 including a placement surface 45 that is a flat surface orthogonal to the up-down direction, and a plate-shaped standing frame 46 forming a standing surface 47 that is a flat surface orthogonal to the front-rear direction, are provided to the rear of the conveyance roller 42.

Both the placement frame 44 and the standing frame 46 extend over substantially the entire housing 14 in the left-right direction, and have a length dimension longer than the scanning shaft 31. The standing frame 46 is attached to a front end part of the placement frame 44.

In the up-down direction, the placement frame 44 is located below the scanning shaft 31, and the standing frame 46 has a lower end part located below the scanning shaft 31 and an upper end part extending above the scanning shaft 31. When two scanning shafts 31 are provided along the up-down direction, the scanning shaft 31 located on the lower side may be located below the lower end part of the standing frame 46.

As shown in FIG. 3, the upper surface of the placement frame 44 is covered with a covering member 48, and the surface of the standing frame 46 facing rearward is covered with a covering member 49.

As shown in FIG. 2, a standing surface part 43 standing upward is provided at a rear end part of the placement frame 44.

The control unit 22 is disposed at a right end part of the placement frame 44. The control unit 22 is disposed to the rear of the scanning shaft 31.

The control unit 22 controls the driving of the carriage 33, the inkjet head 34, and each drive unit of various sensors. The control unit 22 includes a central processing unit (CPU) for executing various programs, and a random-access memory (RAM) for temporarily storing data, programs, and the like. The control unit 22 includes a read-only memory (ROM) in which various data, various programs, and the like are recorded in advance in a non-volatile manner, an interface, and the like. In the control unit 22, the CPU processes various signals input via the interface, based on the data in the RAM and the ROM, and outputs control signals to each drive unit and the like via the interface.

The cable unit 60 that couples the carriage 33 and the control unit 22 is provided on the upper surface of the placement frame 44 and to the rear of the standing frame 46.

The cable unit 60 includes the first cable 62 electrically coupling the carriage 33 and the control unit 22, and the second cable 64 similarly electrically coupling the carriage 33 and the control unit 22. The first cable 62 and the second cable 64 are flexible flat cables (FFC), are formed in an elongated and flat plate shape and have flexibility so as to be able to be bent and curved. In the first cable 62 and the second cable 64, a plurality of electric wires are arranged in parallel along a width direction, which is a direction intersecting a longitudinal direction and a plate thickness direction. The width direction is a direction in which the plurality of electric wires are arranged side by side, and therefore can also be expressed as an arrangement direction.

The first cable 62 is formed such that the width dimension thereof, which is the length dimension in the width direction, is longer than the width dimension of the second cable 64.

The control unit 22 transmits a control signal to the inkjet head 34, for example, via the first cable 62 or the second cable 64, and thus controls the ejection of the ink from the inkjet head 34.

The first cable 62 is an example of a “first flexible flat cable” according to the present disclosure. The second cable 64 is an example of a “second flexible flat cable” according to the present disclosure.

One end part of each of the first cable 62 and the second cable 64 in the longitudinal direction is coupled to a part of the carriage 33 located more to the rear than the scanning shaft 31. The first cable 62 and the second cable 64 extend from the carriage 33, are routed on the upper surface of the placement frame 44 and to the rear of the standing frame 46, and are then coupled to the control unit 22 located further to the rear than the carriage 33 and the scanning shaft 31. Therefore, the first cable 62 and the second cable 64 extending from the carriage 33 extend to the left side on the upper surface of the placement frame 44, are bent to the rear, are further routed to the right, and are coupled to the control unit 22.

The first cable 62 and the second cable 64 are bent to the rear on the upper surface of the placement frame 44 and then fixed by the plurality of fixed clamps 50. The fixed clamp 50 is a member attached to the standing surface part 43 and formed, for example, in an annular shape. The first cable 62 and the second cable 64 are inserted into each of the fixed clamps 50 and are thus routed to extend in the left-right direction along the plane of the standing surface part 43. Each of the fixed clamps 50 is provided side by side at a predetermined interval from a position overlapping a middle part between the two ends of the scanning shaft 31 to the control unit 22 in the standing surface part 43 when viewed from the front-rear direction.

As shown in FIGS. 2 and 3, the cable unit 60 includes a plurality of moving clamps 70. In the longitudinal direction of the first cable 62 and the second cable 64, the moving clamps 70 are provided side by side at predetermined interval from one end part coupled to the carriage 33 to a part fixed to the fixed clamp 50.

The moving clamp 70 is an example of a “clamp”.

As shown in FIG. 3, the moving clamp 70 includes a clamp body 72 that holds the first cable 62 and the second cable 64 in a posture in which one end in the width direction is higher than the other end in the width direction in terms of the vertical direction. The clamp body 72 is formed substantially in a T-shape when viewed from the left-right direction, and includes, at a lower end part, a sliding surface part 74 on which a sliding surface 75 that is a flat surface is formed, and a main body part 76 extending upward from the sliding surface part 74.

The sliding surface part 74 extends with a predetermined length dimension in the front-rear direction. The clamp body 72 is placed on the upper surface of the placement frame 44 in a state where the entire sliding surface 75 is in contact with the covering member 48.

The main body part 76 extends upward from a substantially central part of the sliding surface part 74 in the front-rear direction. The main body part 76 is provided with a first holding part 77 formed as a rear surface 71 facing rearward is recessed to the front side. The first holding part 77 is formed in a groove-like shape recessed to the front when viewed from the left-right direction.

The first holding part 77 includes a front holding surface 77A, which is a flat surface orthogonal to the front-rear direction and substantially parallel to the rear surface 71, an upper end surface 77B, which is a flat surface coupling an upper end part of the front holding surface 77A and the rear surface 71, and a lower end surface 77C, which is a flat surface facing the upper end surface 77B.

The front holding surface 77A is an example of a “holding surface” that holds the first cable 62 along the width direction. The lower end surface 77C is an example of a “support surface” and a “first support surface” that support one end in the width direction of the first cable 62, the second cable 64, or a third cable 66 described later, from below in a posture in which the other end in the width direction is higher than one end in the width direction in terms of the vertical direction.

The upper end surface 77B is a flat surface orthogonal to the up-down direction. On the upper end surface 77B, a rib-shaped support part 78 protruding downward with a predetermined length dimension is provided at an end part located on the rear surface 71 side.

The lower end surface 77C is a flat surface orthogonal to the up-down direction. The upper end surface 77B and the lower end surface 77C are arranged substantially parallel to each other at a predetermined distance in the up-down direction. On the lower end surface 77C, a rib-shaped support part 79 protruding upward with a predetermined length dimension is provided at an end part located on the rear surface 71 side.

A plate-shaped or thin film-shaped cover member 80 may be provided inside the first holding part 77. The cover member 80 is disposed in the first holding part 77 such that the plate thickness direction thereof is along the front-rear direction. An upper end part of the cover member 80 may be attached to the support part 78, and a lower end part thereof may be attached to the support part 79. In this way, the first holding part 77 may be covered by the cover member 80.

The cover member 80 may be omitted.

The main body part 76 includes a second holding part 81 formed as the lower side of the front holding surface 77A of the first holding part 77 is recessed to the front side. The second holding part 81 is formed in a groove-like shape recessed to the front when viewed from the left-right direction.

The second holding part 81 includes a front holding surface 81A that is a flat surface orthogonal to the front-rear direction and substantially parallel to the rear surface 71 and the front holding surface 77A, and an upper end surface 81B that is a flat surface coupling an upper end part of the front holding surface 81A and a lower end part of the front holding surface 77A.

The upper end surface 81B is a flat surface orthogonal to the up-down direction. On the upper end surface 81B, a rib-shaped support part 82 protruding downward with a predetermined length dimension is provided at an end part located on the front holding surface 77A side.

A lower end part of the front holding surface 81A is coupled to a front end part of the lower end surface 77C. That is, the lower end surface 77C forms the lower end part of the second holder 81.

The first cable 62 and the second cable 64 are inserted in the second holding part 81 and thus held by the moving clamp 70. Both the first cable 62 and the second cable 64 are inserted in the second holding part 81 in a state where the width directions thereof are along the up-down direction, and the lower end part of each of the first cable 62 and the second cable 64 abuts on the lower end surface 77C. That is, both the first cable 62 and the second cable 64 are placed on the lower end surface 77C in the state where the width directions thereof are along the up-down direction.

In the second holding part 81, the second cable 64 is disposed adjacent to or in contact with the front holding surface 81A, and the first cable 62 is disposed on the opposite side of the second cable 64 from the front holding surface 81A.

In the second holding part 81, the upper end part of the first cable 62 is supported by the support part 82 from the rear.

As described above, in the second holding part 81, the second cable 64 is sandwiched between the front holding surface 81A and the first cable 62, and the first cable 62 is sandwiched between the second cable 64 and the support part 82. Thus, the occurrence of a positional misalignment of the first cable 62 and the second cable 64 in the front-rear direction, that is, in the plate thickness direction, is suppressed. In addition, in the moving clamp 70, the occurrence of a misalignment of the second cable 64 in the plate thickness direction is suppressed without providing a rib or the like protruding upward at a middle part of the lower end surface 77C in the front-rear direction.

The moving clamp 70 includes a tube clamper 90 attached to the main body part 76. The tube clamper 90 is attached to a front surface 73 facing forward in the main body part 76. The tube clamper 90 is formed substantially in a C shape when viewed from the left-right direction, and an upper end part of the tube clamper 90 is coupled to an upper end part of the main body part 76, and a lower end part of the tube clamper 90 is coupled to a lower end part of the main body part 76.

Each of the ink tubes 35 is sandwiched between the tube clamper 90 and the front surface 73. The plurality of ink tubes 35 are arranged side by side along the up-down direction between the tube clamper 90 and the front surface 73. A flexible buffer material 98 such as a rubber material may be interposed between each of the ink tubes 35 and the front surface 73.

Thus, the moving clamp 70 clamps the first cable 62, the second cable 64, and the plurality of ink tubes 35.

The tube clamper 90 is provided with a plurality of sliding ribs 92 protruding forward on a surface opposite to a surface facing the front surface 73. The sliding ribs 92 are provided side by side along the up-down direction.

Next, the operation of the cable unit 60 with the movement of the carriage 33 will be described.

As described above, when the printing device 1 performs printing, the inkjet head 34 ejects the ink onto the paper P while moving forward and backward together with the carriage 33 in the scanning direction in relation to the paper P and thus prints an image on the paper P.

Therefore, since one end part of the cable unit 60 in the longitudinal direction is coupled to the carriage 33, the cable unit 60 follows the movement of the carriage 33.

When the carriage 33 moves from the right end part to the left end part of the scanning shaft 31, the moving clamp 70 moves to the left along the standing frame 46. In this case, the sliding ribs 92 slide on the surface of the covering member 49, and the sliding surface 75 slides on the upper surface of the covering member 48.

After moving to the left along the standing frame 46, the moving clamp 70 moves from the standing frame 46 toward the standing surface part 43, and the sliding ribs 92 abut on the standing surface part 43.

When the carriage 33 moves from the left end part to the right end part of the scanning shaft 31, the moving clamp 70 slides on the upper surface of the placement frame 44 and moves from the standing surface part 43 toward the standing frame 46. When the sliding ribs 92 abut on the standing frame 46, the moving clamp 70 moves to the right along the standing frame 46 and moves to a predetermined position in the left-right direction according to the position of the carriage 33.

As the carriage 33 moves, the first cable 62 and the second cable 64 are bent or extended in a state where the flat surfaces thereof face each other. When the first cable 62 and the second cable 64 are misaligned in position from each other in the width direction due to bending and extension, the first cable 62 and the second cable 64 may be misaligned in position in the direction in which the electric wires provided therein are arranged, and this may cause a noise.

In the present embodiment, both the first cable 62 and the second cable 64 are held by the moving clamp 70 in a state where the width directions thereof extend along the up-down direction, that is, the vertical direction. Also, the lower end parts of the first cable 62 and the second cable 64 in the width direction abut on the lower end surface 77C. Since the first cable 62 and the second cable 64 are held by the moving clamp 70 in a posture in which the other end in the width direction is higher than the one end in the width direction in terms of the vertical direction, the one end in the width direction is the lower end part in the width direction. In this way, since each of the first cable 62 and the second cable 64 is supported by the lower end surface 77C from below in the vertical direction, even when the first cable 62 and the second cable 64 are bent or extended, the occurrence of a positional misalignment in the width direction is suppressed. Therefore, in the printing device 1, the occurrence of a noise in the cable unit 60 is suppressed.

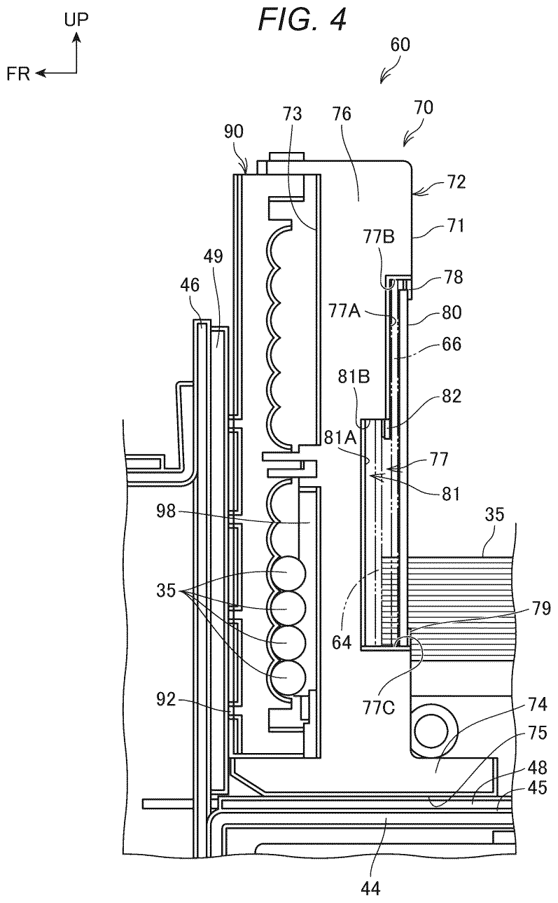

FIG. 4 is a cross-sectional view taken along the line III-III in FIG. 2. FIG. 4 illustrates the cable unit 60 in a case where the printing device 1 includes a third cable 66 having a width dimension longer than that of the first cable 62, instead of the second cable 64.

As illustrated in FIG. 4, when the printing device 1 includes the third cable 66 having a width dimension longer than that of the first cable 62, instead of the second cable 64, the third cable 66 is inserted and held in the first holding part 77 in a state where the width direction thereof is along the up-down direction. The third cable 66 is placed on the lower end surface 77C in the state where the width direction thereof is along the up-down direction. The front side of an upper end part of the third cable 66 is disposed adjacent to or in contact with the front holding surface 77A, and the upper end part is supported by the support part 78 from the rear, and a lower end part is supported by the support part 79 from the rear.

In this way, the moving clamp 70 is provided with the first holding part 77 and the second holding part 81 having different width dimensions in the vertical direction and therefore can hold flexible flat cables of different types having different width dimensions. Also, in the moving clamp 70, both the flexible flat cables held by the first holding part 77 and the second holding part 81 are supported from below by the lower end surface 77C. Therefore, in the printing device 1, a positional misalignment in the width direction of each flexible flat cable held by the moving clamp 70 can be suppressed more securely.

As described above, the moving clamp 70 holds the first cable 62 and the second cable 64 on the rear surface 71 side of the clamp body 72 and holds the ink tubes 35 on the front surface 73 side of the clamp body 72.

Thus, in the printing device 1, for example, when work such as replacing one of the first cable 62 or the second cable 64 and the ink tube 35 is performed, the work can be performed without detaching the other from the moving clamp 70. Therefore, the maintainability of the printing device 1 is improved.

The above-described embodiment is simply an example of one aspect of the present disclosure and can be freely modified and applied without departing from the scope and spirit of the present disclosure.

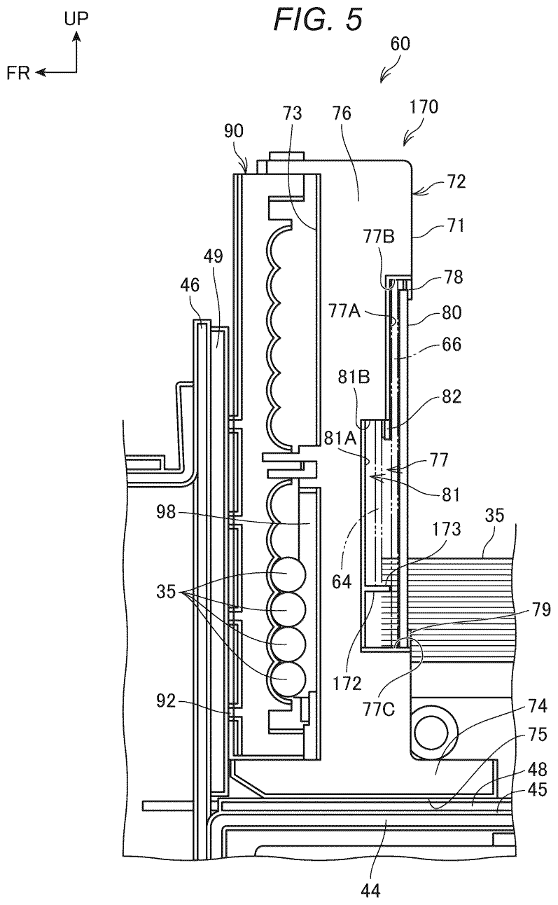

FIG. 5 is a view of a moving clamp 170 according to a modification example of the present embodiment as viewed from the left-right direction. In FIG. 5, the same parts as those in FIG. 3 are denoted by the same reference numerals, and the description thereof will be omitted.

As illustrated in FIG. 5, the printing device 1 may include the moving clamp 170 instead of the moving clamp 70. In the moving clamp 170, the front holding surface 81A is provided with a support rib 172 protruding to the rear from a middle part in the up-down direction. A distal end part of the support rib 172 protrudes to a position overlapping the support part 82 as viewed in a plan view. The support rib 172 is provided with a support surface 173 that is a flat surface orthogonal to the up-down direction. The support surface 173 is arranged above the lower end surface 77C in the up-down direction.

The support surface 173 is an example of a “second support surface” that supports one end of the second cable 64 in the width direction from below.

When the printing device 1 includes the second cable 64 and the third cable 66, the second cable 64 is inserted in the second holding part 81 and thus held by the moving clamp 170. The second cable 64 is inserted in the second holding part 81 and the lower end part thereof abuts on the support surface 173, in a state where the width direction of the second cable 64 is along the up-down direction.

In the second holding part 81, the front side of the second cable 64 is disposed adjacent to or in contact with the front holding surface 81A, and the upper end part thereof is supported by the support part 82 from the rear.

In this way, in the printing device 1, since the moving clamp 170 supports the second cable 64 and the third cable 66 having different width dimensions from each other from the lower end parts in the width direction, the second cable 64 and the third cable 66 can be held while the generation of a noise is suppressed.

In the above-described embodiment, in the printing device 1, the flexible flat cables having different width dimensions are held by the moving clamps 70 and 170. However, the present disclosure is not limited thereto, and in the printing device 1, the flexible flat cables having substantially the same width dimension may be held by the moving clamps 70 and 170. Also, for example, three or more flexible flat cables may be held by the moving clam 70, 170.

In the above-described embodiment, the upper surface of the placement frame 44 is a substantially horizontal flat surface orthogonal to the up-down direction. However, the present disclosure is not limited thereto, and the upper surface of the placement frame 44 may be an inclined surface facing upward and inclined in any direction.

In this case, in the moving clamps 70 and 170, the sliding surface 75 may be formed as an inclined surface inclined in substantially the same direction as the upper surface of the placement frame 44, and the lower end surface 77C and the support surface 173 may be formed as a substantially horizontal flat surface orthogonal to the up-down direction.

Also, for example, when the upper surface of the placement frame 44 is an inclined surface facing upward and inclined in any direction, the lower end surface 77C and the support surface 173 may be inclined surfaces facing upward and inclined in any direction as long as these surfaces can support the flexible flat cables from below.

When the moving clamps 70 and 170 move with the movement of the carriage 33, the description of the directions related to the moving clamps 70 and 170 described above changes depending on the orientation of the moving clamps 70 and 170 at the time, except for the up-down direction.

The printing device 1 may be any device that includes the carriage 33 and performs printing.

The directions such as the horizontal and vertical directions and the various shapes in the above-described embodiment include an equivalent range that achieves the same functions and effects as those of the directions and shapes unless otherwise specified.

### Summary of Present Disclosure

A summary of the present disclosure will be appended below.

### Appendix 1

A printing device includes: a carriage on which an inkjet head is mounted and which can scan a print medium; a control unit which controls the inkjet head; a first flexible flat cable which electrically couples the carriage and the control unit and in which a plurality of electric wires are disposed in parallel along a width direction; a second flexible flat cable which electrically couples the carriage and the control unit and in which a plurality of electric wires are disposed in parallel along the width direction; and a clamp which holds the first flexible flat cable and the second flexible flat cable, in which the clamp includes a support surface which supports each of the first flexible flat cable and the second flexible flat cable from one end in the width direction in a posture in which the other end in the width direction is higher than one end in the width direction in terms of a vertical direction.

Thus, in the printing device, the first flexible flat cable and the second flexible flat cable are held in contact with the support surface due to gravity. Therefore, in the printing device, the occurrence of a positional misalignment of the first flexible flat cable and the second flexible flat cable from each other is suppressed and the generation of a noise can be reduced.

### Appendix 2

In the printing device according to Appendix 1, the clamp includes a holding part configured to hold the first flexible flat cable, and the holding part is provided with a holding surface that holds the first flexible flat cable along the width direction, and a support part that supports an upper end part of the first flexible flat cable.

Thus, in the printing device, the first flexible flat cable is held in a state of being supported by the support part, and thus the first flexible flat cable is prevented from being spaced apart from the support surface.

### Appendix 3

In the printing device according to Appendix 2, the second flexible flat cable is disposed between the holding surface and the first flexible flat cable.

Thus, in the printing device, the second flexible flat cable can be held without providing a structure for supporting the second flexible flat cable from the plate thickness direction in the clamp.

### Appendix 4

In the printing device according to any one of Appendices 1 to 3, the first flexible flat cable is formed with a first width dimension, and the second flexible flat cable is formed with a second width dimension different from the first width dimension.

Thus, the occurrence of a positional misalignment of the first flexible flat cable and the second flexible flat cable from each other in the vertical direction is suppressed and the generation of a noise can be reduced.

### Appendix 5

In the printing device according to any one of Appendices 1 to 4, the support surface includes a first support surface that supports one end of the first flexible flat cable in the width direction from below, and a second support surface that supports one end of the second flexible flat cable in the width direction from below, and the first support surface and the second support surface are disposed at different positions in the vertical direction.

Thus, the first flexible flat cable and the second flexible flat cable are held at positions different from each other in the vertical direction, and the generation of a noise is reduced.

What is claimed is:

1. A printing device comprising:
a carriage on which an inkjet head is mounted and which is configured to be able to scan a print medium;
a control unit configured to control the inkjet head;
a first flexible flat cable which is configured to electrically couple the carriage and the control unit and in which a plurality of electric wires are disposed in parallel along a width direction;
a second flexible flat cable which is configured to electrically couple the carriage and the control unit and in which a plurality of electric wires are disposed in parallel along the width direction; and
a clamp configured to hold the first flexible flat cable and the second flexible flat cable, wherein
the clamp includes a support surface which supports each of the first flexible flat cable and the second flexible flat cable from one end in the width direction in a posture in which the other end in the width direction is higher than one end in the width direction in terms of a vertical direction.

2. The printing device according to claim 1, wherein
the clamp includes a holding part configured to hold the first flexible flat cable, and
the holding part is provided with
a holding surface that holds the first flexible flat cable along the width direction, and
a support part that supports an upper end part of the first flexible flat cable.

3. The printing device according to claim 2, wherein
the second flexible flat cable is disposed between the holding surface and the first flexible flat cable.

4. The printing device according to claim 1, wherein
the first flexible flat cable is formed with a first width dimension, and
the second flexible flat cable is formed with a second width dimension different from the first width dimension.

5. The printing device according to claim 1, wherein
the support surface includes
a first support surface that supports one end of the first flexible flat cable in the width direction from below, and
a second support surface that supports one end of the second flexible flat cable in the width direction from below, and
the first support surface and the second support surface are disposed at different positions in the vertical direction.
